(19) United States
(12) Patent Application Publication
(10) Pub. No.: US 2026/0170032 A1
(43) Pub. Date: Jun. 18, 2026

(54) DETECTION AND CLASSIFICATION TECHNIQUES USING LARGE LANGUAGE MODELS

(71) Applicant: THE HUNTINGTON NATIONAL BANK, Columbus, OH (US)

(72) Inventor: Brian P. Long, Columbus, OH (US)

(73) Assignee: THE HUNTINGTON NATIONAL BANK, Columbus, OH (US)

(21) Appl. No.: 18/982,689

(22) Filed: Dec. 16, 2024

(51) Int. Cl. G06F 16/334; G06F 16/353

(52) U.S. Cl. CPC G06F 16/3344; G06F 16/353

(57) ABSTRACT

Techniques are described herein for anomaly detection and/or classification which may include obtaining a large language model (LLM) that has been trained to classify instances of input data based at least in part on a plurality of classes. Input data corresponding to at least one data instance that is associated with a user may be provided to the LLM to obtain output data that identifies one or more classes for the input data. In some embodiments, it may be determined whether the input data is anomalous based at least in part on the output data received from the LLM. One or more labels or the input data may be determined based at least in part on the output data received from the LLM. One or more operations may be executed based at least in part on the output data received from the LLM.

### BACKGROUND

Many industries such as quality control in chemical and industrial manufacturing implement various anomaly detection techniques to find potential issues. For example, many chemical manufacturers source various ingredients in compounds from various sites across the world with a “data trail” identifying where each ingredient came from along with associated identifiers. If a particular compound is bad or has an issue, it is important to be able to trace back the data trial to uncover what value may have been anomalous. Conventional anomaly detection methods have relied on statistical methods such as isolation forest statistics that divide complex datasets until an anomaly is isolated and identified. However, these methods may fail for complex and/or large datasets. Additionally, it may be beneficial, in addition to anomaly detection, to further differentiate between various types of data being received. However, conventional systems lack the ability to perform such classifications in the course of typical anomaly detection.

### TECHNICAL FIELD

This disclosure generally relates to data classification and anomaly detection, and more particularly to systems, methods, and non-transitory, computer-readable media that may use one or more large language machine-learning models to classify data and/or to monitor for or detect anomalous data.

### BRIEF SUMMARY OF THE INVENTION

Techniques are provided for detecting anomalies and classifying data using large language models that have been trained to classify input data based on classifications. Various embodiments are described herein, including methods, systems, non-transitory computer-readable storage media storing programs, code, or instructions executable by one or more processors, and the like.

One embodiment is directed to a computer-implemented method for detecting anomalies in input data. A computer implemented method comprises providing, by a computing device to a large language model (LLM) as input, input data corresponding to at least one data instance that is associated with a user. The method may further comprise, based at least in part on providing the input data to the LLM, obtaining, by the computing device, output data identifying one or more classes for the input data. The method may further comprise determining, by the computing device, whether the input data is anomalous based at least in part on the output data received from the LLM. The method may further comprise determining, by the computing device, one or more labels for the input data based at least in part on the output data received from the LLM. The method may further comprise executing, by the computing device, one or more operations based at least in part on the output data received from the LLM.

In some embodiments, the input data is provided in a prompt, the prompt further comprising at least one of: a first set of classes comprising an anomalous class or non-anomalous class, a second set of classes corresponding to a set of categories, a third set of subcategories, or a fourth set of classes corresponding to respective codes or identifiers.

In some embodiments, the input data is provided in a prompt, the prompt further comprising one or more input data instances that are individually associated with the user.

In some embodiments, the input data is provided in a prompt, the prompt further comprising one or more input data instances that are individually associated with a plurality of users.

In some embodiments, the one or more operations comprises presenting, at a network page that is associated with the user, the one or more labels of the output data differ from an indication of anomalous and non-anomalous behavior.

In some embodiments, the one or more operations comprises at least one of: declining further processing of the data instance, adjusting a parameter corresponding to the input data, triggering a review process of the user, presenting the one or more labels at a user interface, generating aggregate data of at least one additional data instance corresponding to the user based at least in part on the one or more labels, or initiating or adjusting a monitoring process for monitoring the user.

In some embodiments, the computer implemented method further comprises determining, by the computing device, that the output data received from the LLM does not conform to a format, and providing, by the computing device to the LLM as an additional prompt, the format and the transactions data.

In some embodiments, a system comprises one or more processors and one or more memories storing computer-executable instructions that, when executed by the one or more processors, causes the one or more processors to perform the method(s) disclosed herein.

In some embodiments, a non-transitory computer-readable storage medium storing computer-executable instructions that, when executed with one or more processors of a computing device, causes the computing device to perform the method(s) disclosed herein.

### BRIEF DESCRIPTION OF THE DRAWINGS

Various embodiments in accordance with the present disclosure will be described with reference to the drawings, in which:

FIG. 1 is a simplified example flow for detecting an anomaly, in accordance with at least one embodiment;

FIG. 2 is a simplified example prompt, in accordance with at least one embodiment;

FIG. 3 is a simplified block diagram illustrating an example process for detecting anomalous data instances and/or classifying data instances, in accordance with at least one embodiment;

FIG. 4 is a simplified schematic diagram of an example system for anomaly detection and classification, in accordance with at least one embodiment;

FIG. 5 is a simplified schematic diagram of an example computer architecture for an anomaly detection and classification engine, including a plurality of modules that may perform functions in accordance with at least one embodiment; and

FIG. 6 is a block diagram illustrating an example method for detecting anomalies and/or classifying data, in accordance with at least one embodiment.

### DETAILED DESCRIPTION

In the following description, various embodiments will be described. For purposes of explanation, specific configurations and details are set forth to provide a thorough understanding of the embodiments. However, it will be apparent to one skilled in the art that the embodiments may be practiced without the specific details. Furthermore, well-known features may be omitted or simplified in order not to obscure the embodiment being described.

Some or all of the process (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Techniques are provided for detecting anomalies using large language models. Identifying anomalies as early as possible is any industry is highly desirable. For example, many manufacturing industries (e.g., wafer, chemical, materials, etc.) rely on computer networked infrastructure to function correctly. As a non-limiting example, for an automative manufacturer, anomaly detection can identify signs of mechanical failure before a breakdown occurs allowing for repair, replacement of components, and preventive measures which may save lives. Robust anomaly detection may lead to increased production, efficiency improvements, improved risk management, storage and processing savings, and the like.

The disclosed techniques disclosed herein provide improvements to anomaly detection by leveraging a large language model (LLM). A “large language model” is intended to refer to an artificial intelligence model (e.g., BERT, LaMDA, LLaMA, or the like) that is trained to understand natural language input and to generate output based on being training that included a vast number of training data examples, potentially across a variety of modalities (e.g., books, articles, web pages, etc.). An LLM may be configured to mimic human behavior to perform tasks like text generation, translation, question answering, summarization, among other tasks. Systems and methods described herein are capable of generating and/or aggregating input data, which may include any suitable number of data instances. This input data may be transformed, converted, and/or formatted to generate a LLM specific prompt. The input data can include any suitable user data along with similar descriptors (e.g., user data that includes attributes and corresponding attribute values. The prompt may be provided as input to the LLM (e.g., a third-party provided LLM, etc.). The LLM may provide output (e.g., a classification indicating whether the data instance is anomalous) that indicates whether an anomaly is detected in the input data of the prompt. Beneficially, the LLM may process hundreds of thousands of input data instances and may provide reliable anomaly detection in a timely manner. Conventional techniques, which are processing power intensive, may lack the ability to make such determinations as accurately and/or within the same amount of time. Moreover, unlike some conventional techniques, the LLM need not have historical data related to specific data instance examples to make a determination since the determination may be made in real-time based on supervised or unsupervised learning and with potentially more dimensions than conventional algorithms may provide.

It may be beneficial to further classify data instances (e.g., data instances that are associated with a user). By way of example, it may be helpful to classify data instances according to a set of categories and/or subcategories and/or to identify national code identifiers for a data instance. In some embodiments, a system may aggregate attributes/attribute values of data instances that are associated with the same category, subcategory, and/or national code identifier to present aggregated values to a user via one or more user interfaces. In some embodiments, these additional classifications (e.g., categories, subcategories, and/or national code identifiers) may be further used by the LLM to determine whether a data instance is anomalous. However, conventional systems do not utilize such classifications when determining anomalous behavior. Even if such systems further classify data, they do not do so in the same process that is conducted when attempting to detect anomalies. This leads to wasted processing resources and latency.

The disclosed techniques disclosed herein provide several advantages such as improving the accuracy of detecting anomalies in input data comprising a large number of data instances as well as on an individual input data instance level. The robust dimensional analysis LLMs provide an improved security defense when used to detect anomalous behavior (e.g., fraud and/or other security related anomalies) and may reduce the latency in making these determinations. The disclosed techniques can minimize the risk of overlooking anomalous activity by using the enhanced identification capabilities of LLMs to protect users as well as data managing entities that serve those users. By detecting anomalies as soon as possible, wasteful user of processing resources may be avoided, improving the throughput of the system as a whole. Furthermore, as described above, conventional systems do not further classify data using categories, subcategories, and/or national code identifiers, and certainly not as part of the same process that is executed to detect anomalous behavior. By utilizing the techniques described herein, an LLM may be used to determine whether a data instance is anomalous as well as to assign one or more categories, subcategories, and/or national code identifiers without requiring multiple inputs or separate processes. These categories, subcategories, and/or national code identifiers may be used by the LLM when determining whether the data instance is anomalous. This improved processing resource use, reduces latency in making such identifications (e.g., by utilizing on input instance rather than multiple, separate processes), and enables more robust anomaly detection than previously realized in conventional systems. Additionally, utilization of the LLM as disclosed herein relieves entities from performing an often, slow, laborious process of gathering large amounts of data with which to train a machine-learning or statistical model while providing robust classification even on novel data.

Conventional systems would hard code categories, subcategories, and/or codes/identifiers and were unable to identify data instances corresponding to entities that had not been hardcoded. For example, these conventional systems may have a predefined map to identify an entity name (e.g., a merchant name) and to map the name to a specific category and/or subcategory. This is problematic for conventional systems when data corresponding to a new entity is encountered. The present disclosure remedies these deficiencies by being agnostic towards a source of data, enabling the disclosed techniques well suited for making reliable determinations on anomalous/non-anomalous data and/or for category, subcategory, and/or code/identifier, without pre-existing maps, historical records, and/or data which has never been processed before.

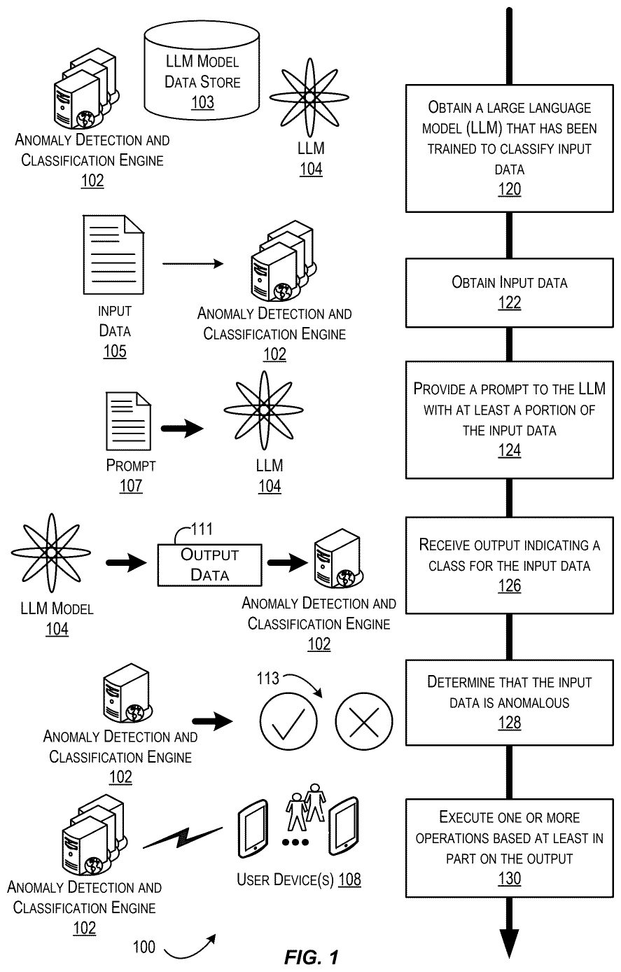

Moving on to FIG. 1 which illustrates simplified example flow 100 for detecting anomalies, in accordance with at least one embodiment. The operations discussed in connection with FIG. 1 may be performed with an anomaly detection and classification engine 102 (hereinafter “ADE 102”). In some embodiments, ADE 102 may be implemented by one or more computer(s), as a service, within an application, or the like. The operations discussed in connection with FIG. 1 may be performed in any suitable order. More or fewer operations than those depicted in FIG. 1 may be employed without diverting from this disclosure.

The flow 100 may begin at block 120, where the ADE 102 obtains access to a large language model (LLM) 104 that may be previously trained to classify data based on a set of one or more classes. The classes may include one or more classes indicating whether the input data is anomalous, non-anomalous, or indeterminate. If the data is determined to be anomalous (e.g., the data is determined to include an outlier instance with respect to various data instances of the input data) it may be classified by the LLM 104 as belonging to an anomalous class. If the data is determined to be typical (e.g., the data is determined to include typical data instances and no outlier data instances), the LLM 104 may classify the input data as belonging to a non-anomalous class.

If the data is neither determined to be anomalous or non-anomalous, the LLM 104 may classify the input data as belonging to an indeterminate class. The ADE 102 may have access to a LLM data store 103 where data (e.g., access information such as an application programming interface) corresponding to one or more LLMs 104 (e.g., GPT-4™, Cohere, LLaMA, etc.) may be stored for access.

At 122, input data 105 (e.g., account transactions, data instances corresponding to a user, etc.) may be obtained from one or more source(s) (e.g., data providers, service providers, or the like). For example, a data provider (e.g., a financial institution) may provide input data including one or more data instances (e.g., transactions from a given day) for processing to the ADE 102. The ADE 102 may receive those the input data and perform various formatting operations in preparation for providing the input data to the LLM 104. Without limitation, a data provider “providerXYZ” may submit the one or more data instances as input data 105. The input data 105 could include data such as, but not limited to, quantities, brief descriptions, identifiers, classifications, categories, subcategories, codes/identifiers, or any suitable data.

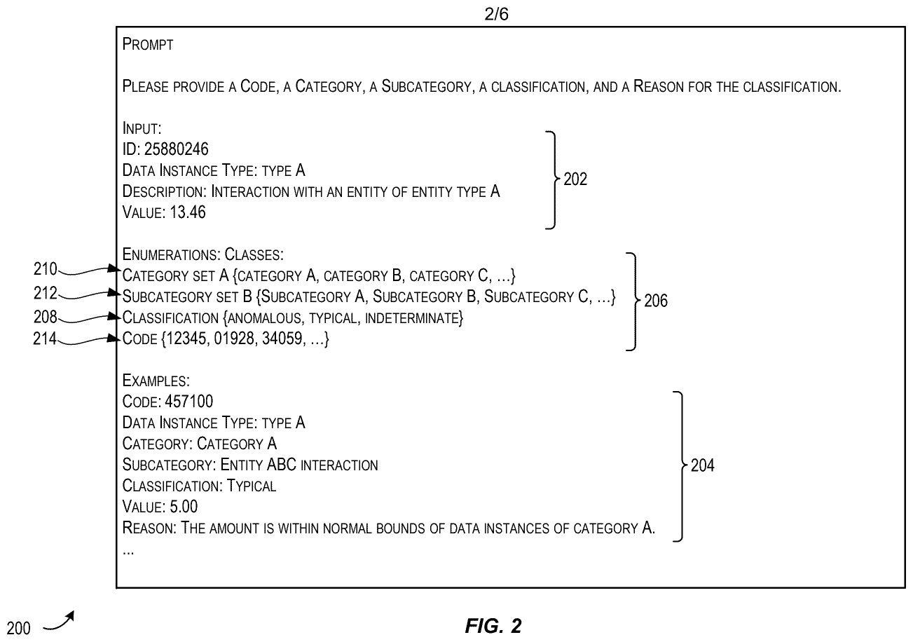

At 124, the ADE 102 may format the received input data 105 as a prompt 107 for a respective LLM (e.g., LLM 104) to analyze. An LLM prompt (or “prompt,” for brevity) may include a query, instruction, or input data that, when provided as input to an LLM, elicits a response. The prompt 107 may include details related to the input data 105 (discussed in more detail with respect to FIG. 2) and be formatted for the LLM 104. By way of example, the prompt 107 for a selected LLM 104 (e.g., GPT-4™) may include the input data from the collection of data instances and additional descriptors to aid the LLM 104 in providing a suitable response (e.g., a classification from a set of classes). As a non-limiting example, the prompt 107 may include details relating to a description (e.g., an amount corresponding to a data instance) and instructions to set a foundation of response for the LLM 104 (e.g., “Identify anomalous transactions for a data instance and/or transaction categories, subcategories, and/or codes/identifiers for the data instance”).

At 126, the ADE 102 may receive an output data 111 (e.g., a response) from the LLM 104 indicating a classification for the input data 105. The output data 111 may identify one or more classes to which the input data 105 is determined to belong. The classes may include any suitable number of classes identified from any suitable number of class sets. By way of example, one classification for the input data 105 may include a class of a first set of classes (e.g., a anomalous/non-anomalous/indeterminate class) and/or one of a second class selected from a second set of classes (e.g., data categories like “food,” “clothing,” “gas,” “utilities,” or the like).

At 128, the ADE 102 may make a determination 113 that the input data 105 may be anomalous (e.g., belonging to one or more anomalous classes) based on the output data 111 from the LLM 104. The ADE 102 may include instructions that may actively process the output data 111 received from the LLM 104 to identify sections in the output data 111 that may indicate whether or not the input data is anomalous. For example, the ADE 102 may identify the classification the LLM 104 provided and make the determination that the input data 105 is anomalous. In addition, or alternatively, the ADE 102 may classify the input data 105 as belonging to one or more additional sets of classes (e.g., a category of a categories class, a subcategory of a subcategories class, a code/identifier of a code/identifier class, or the like).

At step 130, the ADE 102 may execute one or more operations based at least in part on the determination 113 of the output data 111. The operations may include notifying one or more user device(s) 108 (e.g., smart phone, server computer, etc.) regarding the anomalous classification. By way of a non-limiting example, the operations include pausing or declining processing of a data instance corresponding to the input data 105. By taking action by way of the operations that the ADE 102 performs, wasted processing and latency may be avoided.

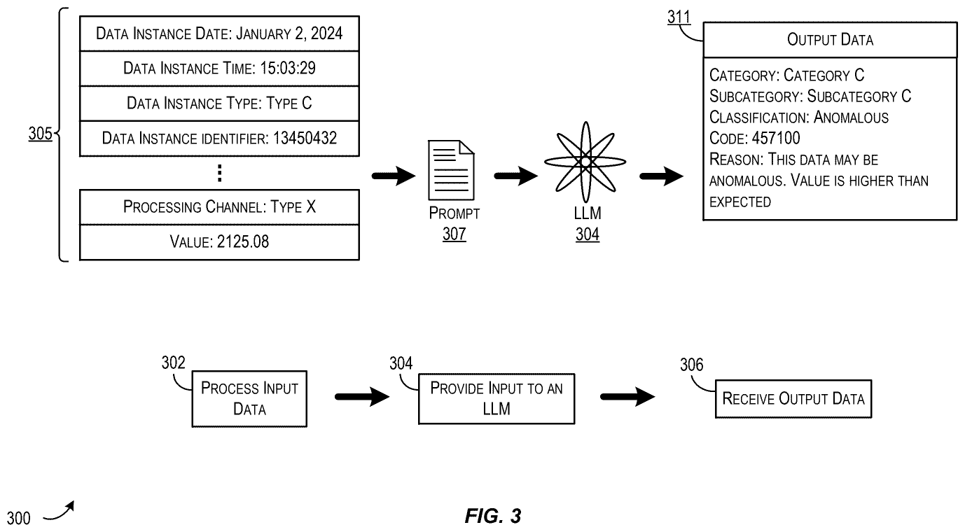

FIG. 2 is a simplified example of a prompt 200 (e.g., prompt 107 of FIG. 1), in accordance with at least one embodiment. As discussed with respect to FIG. 1, the prompt 200 may be generated by the ADE 102 of FIG. 1 in response to receiving the input data (e.g., input data 305 with respect to FIG. 3) from a source. By way of example, when the ADE 102 receives the input data, various sections within the input data may be parsed and identified in preparation for insertion into the prompt 200. As a non-limiting example, one data instance (e.g., a most-recent data instance that has not been assigned a category, subcategory, anomaly classification, and/or code/identifier), may be provided as input 202, while one or more data instances that have any suitable combination of an associated category, subcategory, anomaly classification, or code/identifier may be provided as examples (e.g., example 204).

The ADE 102 may parse and obtain any suitable portion of any suitable number of data instances. By way of example, a batch of data instances may be obtained and the ADE 102 may parse each transaction within the batch into separate prompts for subsequent processing by an LLM (e.g., LLM 104 with respect to FIG. 1). In addition, or alternatively, the ADE 102 may combine some or all of the data instances into a single prompt or a suitable number of prompts. Prompt 200 is intended to represent a prompt that includes a single or multiple number of data instances.

The ADE 102 may select an appropriate LLM based on a number of factors including, without limitation, a format of prompt 200, a type of LLM, an agreement to use the LLM, data the LLM has been trained on (e.g., specialized LLMs), processing speed of the LLM, data requirements of the LLM, ease of use of the LLM, processing power of the LLM, reliability of answers (e.g., robustness), or combinations thereof. In some embodiments, the ADE 102 constructs the prompt 200 to inform the selected LLM about the context of the prompt 200. The ADE 102 may select a suitable LLM based on a type of training with which the LLM has been trained. In some embodiments, the ADE 102 may be configured to select one of the first set of LLMs depending on the context for which the LLM is being used (e.g., to determine anomalous activity within a user's account).

The prompt 200 may be catered to the specific LLM and include content and format instructions and/or information relevant to the desired task the ADE 102 assigns to the LLM. For example, the prompt 200 may include a query such as “Please provide a code, a category, a subcategory, an anomaly classification, and a reason for the classification”. In regard to the format, the ADE 102 may provide a desired format of a response. For example, the ADE 102 may provide an example response for the LLM to match:
i) Code:
ii) Category:
iii) Subcategory:
iv) Anomaly Classification:
v) Reason: The ADE 102 may provide several examples (e.g., example 204) to the LLM and/or may provide examples based on the input data. For example, if the input data includes over a threshold number of data instances (e.g., over 100 data instances, over 1000 data instances, etc.), the ADE 102 may partition the data instances into prompt groups based on similar prompt formats in order to, without limitation, reduce memory requirements, reduce processing power requirements, reduce the amount of data the LLM needs to process to make a determination, reduce the time taken the process the input data, or any suitable combination thereof. For example, if the input data includes ten thousand data instances, rather than transforming the ten thousand data instances into ten thousand separate prompts, the ADE 102 may identify which data instances have common features (e.g., amounts, data instance type, etc.) and group all of the transactions having a common feature into a single prompt. In this manner, the ADE 102 may provide, without limitation, a reduced number of prompts than the number of prompts needed were a prompt to be provided for each data instance.

The ADE 102 may determine an optimal grouping within the input data to ensure that the LLM can process the prompt 200 effectively. Some LLMs have character limits that may limit the amount of input data that may be analyzed. In these instances, the ADE 102 may partition the input data into a corresponding number of prompts 200 within the character limit of the LLM. It should be readily recognized that the prompt 200 created can include any suitable number of descriptors related to the input data. The prompt 200 may be transmitted to the respective LLMs according to a schedule, frequency, and/or on request (e.g., by a user requesting analysis).

The prompt 200 may include classes 206 for the LLM to use to classify the input data. In some embodiments, classes 206 may include any suitable number of class sets from which a class may be identified for a prompt 200. For example, the prompt 200 may include a first set of classes (e.g., class set 208). For example, class set 208 may include an anomalous class, a typical class, and/or an indeterminate class. The anomalous class may represent data instances that may be considered outliers (e.g., transactions that are performed maliciously without a user's consent, data that contains an outlier outside of an average or normal distribution, etc.). The typical class may represent data instances that are deemed to conform with the other data instances provided as an input. The indeterminate class may represent data instances for which the LLM may be unable to classify. In these instances, the ADE 102 may be configured to provide a subsequent prompt in response to receiving an indeterminate class identifier as output from the LLM 104. In some embodiments, the subsequent prompt may include data that differs from the initially provided prompt (e.g., user specific account history that was not provided in the initial input data). In some examples, the ADE 102 may flag the indeterminate class for further analysis by the LLM and/or a user.

The prompt 200 may include any suitable number of class sets. For example, the prompt 200 may include a second set of classes (e.g., category set 210) corresponding to a set of categories (e.g., category a, category b, category c, etc.). The categories included in the category set 210 may depend on the context in which the LLM is used.

In some embodiments, the prompt 200 may include a third set of classes (e.g., subcategory set 212) that may include any suitable number of subcategories (e.g., subcategory a, subcategory b, subcategory c, etc.). The subcategories included in the subcategory set 212 may depend on the context in which the LLM is used. As another example, the prompt 200 may include a fourth set of classes (e.g., code set 214) corresponding to any suitable number of codes/identifiers (e.g., an identifier such as a North American Industry Classification System (NAICS) code, a phone number, a zip code, a street number, an address, a name, or the like).

As a non-limiting example, input 202 may include an ID (e.g., “25880246”) which may be an identifier that uniquely identifies a data instance corresponding to the input, a data instance type where “type A” may indicate a card transaction, a description where “interaction with an entity of entity type A” may indicate a gas station, and a value that may indicate a purchase amount.

FIG. 3 is a simplified block diagram illustrating an example process 300 for detecting anomalous data instances and/or classifying data instances, in accordance with at least one embodiment. The process 300 of FIG. 3 may incorporate the processes or be implemented as part of the devices, systems, and/or methods discussed herein. The process 300 may begin at 302, where input data 305 may be processed to identify various portions and/or sections of information to be included within the prompt 307. The input data 305 may be an example of the input data 105 of FIG. 1 and the prompt 307 may be an example of the prompt 107 of FIG. 1. The input data 305 may include, without limitation, a data instance value (e.g., a monetary amount), a data instance type (e.g., debit/credit transaction), a date (e.g., day/month/year associated with the data instance), a time (e.g., a time associated with the data instance), one or more names (e.g., a name of a party associated with the data instance), one or more identifies (e.g., an account identifier, a national code associated with an entity such as a gas station, etc.) , a processing channel (e.g., a processing network, a blockchain network, etc.), a category, a subcategory, a classification, a value, or combinations thereof.

At 304, the ADE 102 may provide the input data 305 in the form of a prompt 307 to a LLM 104 (as discussed with respect to FIG. 2).

At 306, output data 311 may be received from the LLM 304. In some embodiments, output data 311 may identify one or more classes for the input data 305 that was embedded, at least in part, in the prompt 307. The output data class (as discussed in more detail with respect to FIG. 2) may be provided as part of a report (e.g., using a graphical user interface (GUI) of a network page) and/or presented to a user on a user device (e.g., user device(s) 108 with respect to FIG. 1).

In some embodiments, output data 311 may include any suitable combination of attributes/values provided as part of input data 305 and one or more additional data attribute/values determined by the LLM 304. The attributes/values of output data 311, as depicted in FIG. 3, include one or more attributes/values identified by the LLM 304 based at least in part on receiving prompt 307.

As a non-limiting example, input data 305 may include a date (e.g., Jan. 2, 2024), a time (e.g., 15:03:29 corresponding to 3:03:29 PM), a type (e.g., type C, corresponding to card transaction), an identifier (e.g., an account identifier), a processing channel (e.g., a processing network), and a value (e.g., an amount, in dollars). The output data 311 provided by the LLM 304, as depicted in FIG. 3, includes a category (e.g., category C, corresponding to “food,” a subcategory (e.g., subcategory C, corresponding to “groceries”), a classification (e.g., anomalous, indicating the data instance was deemed anomalous), a code (e.g., a national industry code for the recipient of the amount), and a reason (e.g., a reason for which the LLM 304 deemed the input data of prompt 307 as being indicative of an anomaly), all of which may be identified by LLM 304 based on the prompt 307.

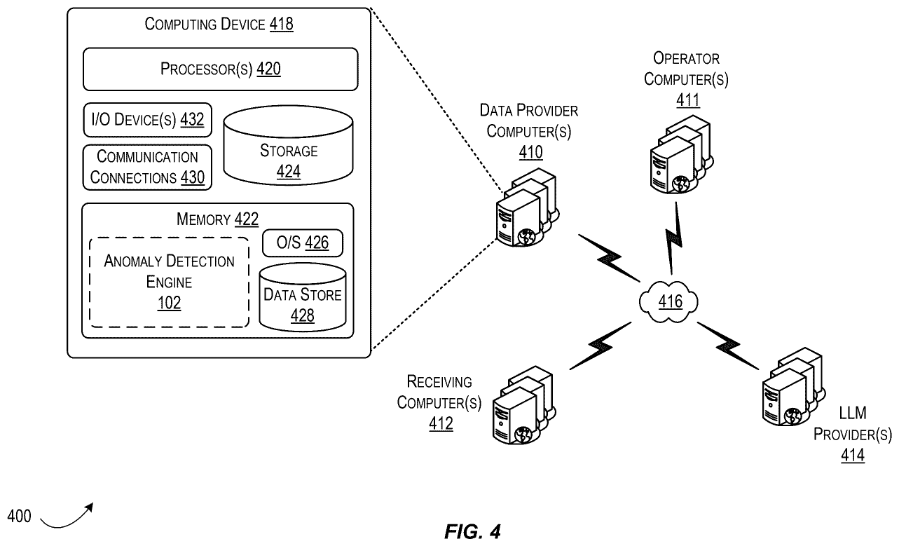

FIG. 4 is a simplified schematic diagram of an example system 400 for anomaly detection and classification, in accordance with at least one embodiment. The system 400 may be incorporated as a component and/or work in conjunction with devices, systems, and methods herein. System 400 may be an example of an anomaly detection and/or classification system in which a variety of computing devices may interact to provide a reliable system for detecting anomalies and/or classifying data instances. The Data Provider Computer(s) 410, the Operator Computer(s) 411, the Data Receiving Computer(s) 412, may be operated on behalf of one or more entities (e.g., one or more financial institutions, etc.).

Data Provider Computer(s) 410 may be operated on behalf of an originator that initially has access to input data. An input data may include any suitable number of data instances values, data instance types, categories, subcategories, classifications, codes, identifiers, names, amounts/values, any suitable number of descriptors, or combinations thereof. As a non-limiting example, one or more data instances may be initiated from Data Provider Computer(s) 410 and transmitted to Receiving Computer(s) 412.

In some embodiments, Data Provider Computer(s) 410 may be associated with an entity participating in a network (e.g., a transaction network) and may be configured to initiate and/or process one or more data transactions (e.g., a data instance such as the input data 305 of FIG. 3) to Operator Computer(s) 411. Operator Computer(s) 411 may be configured to receive data instances/input data from various Data Provider Computer(s) 410 and may process and/or forward any suitable data related to those data instances to Receiving Computer(s) 412. Operator Computer(s) 411 may be further configured to perform functions for the participating entities. Data Receiving Computer(s) 412 may be operated on behalf of another entity and may be configured to receive data instances/input data from the Operator Computer(s) 411. In some embodiments, the Data Receiving Computer(s) 412 may be configured to perform operations. Receiver Computer(s) 412 may be previously authorized by the originator associated with the Data Provider Computer(s) 410 to initiate the operation (e.g., a transaction, a push or pull to or from an account, etc.).

In some embodiments, LLM Provider(s) 414 may include a number of sources of one or more LLMs. The LLM Provider(s) 414 may be accessed/accessible by one or more of the Data Provider Computer(s) 410, the Operator Computer(s) 411, the Data Receiving Computer(s) 412, or other entities connected over network 416. The LLM Provider(s) 414 may include third-party providers of LLM or may include LLMs stored on a server accessible to the Data Provider Computer(s) 410, the Data Receiving Computer(s) 412, and/or the Operator Computer(s) 411.

In some embodiments, the Data Provider Computer(s) 410, the Operator Computer(s) 411, the Data Receiving Computer(s) 412, and/or the LLM Provider(s) 414 may be configured to communicate via network 416. Network 416 may include any suitable combination of many different types of networks, such as cable networks, the Internet, wireless networks, cellular networks, and other private and/or public networks.

The Data Provider Computer(s) 410, the Operator Computer(s) 411, the Data Receiving Computer(s) 412, and the LLM Provider(s) 414 may each be an example of the computing device 418. In some embodiments, the computing device 418 and may include one or more processors (e.g., processor(s) 420). The processor(s) 420 may be implemented in hardware, computer-executable instructions, firmware, or combinations thereof. Computer-executable instruction or firmware implementations of the processor(s) 420 may include computer-executable or machine-executable instructions written in any suitable programming language.

Computing device 418 may include memory 422. The memory 422 may store computer-executable instructions that are loadable and executable by the processor(s) 420, as well as data generated during the execution of these programs. The memory 422 may be volatile (such as RAM) and/or non-volatile (such as ROM, flash memory, etc.). The computing device 418 may include additional storage (e.g., storage 424), which may include removable storage and/or non-removable storage. Storage 424 may include, but is not limited to, magnetic storage, optical disks and/or tape storage. The disk drives and their associated computer-readable media may provide non-volatile storage of computer-readable instructions, data structures, program modules, and other data for the computing devices.

The memory 422 and/or storage 424 may be examples of computer-readable storage media. Computer-readable storage media may include volatile, or non-volatile, removable, or non-removable media implemented in any method or technology for storage of information such as computer-readable instructions, data structures, program modules, or other data. In some embodiments, memory 422 and the storage 424 are examples of computer storage media. Memory 422 and/or additional storage 424 may include, but are not limited to, any suitable combination of PRAM, SRAM, DRAM, RAM, ROM, EEPROM, flash memory or other memory technology, CD-ROM, DVD, magnetic tape, magnetic disk storage or other magnetic storage devices, or any other medium which can be used to store desired information, and which can be accessed by the computing device 418. Computer-readable media may include computer-readable instructions, program modules, or other data transmitted within a data signal, such as a carrier wave, or other transmission. However, as used herein, computer-readable storage media does not include computer-readable communication media.

The memory 422 may include an operating system 426 and one or more data stores 428, and/or one or more application programs, modules, or services. The computing device may also contain communications connection(s) 430 that allow the computing device 418 to communicate with a stored database, another computing device, a server, user terminals and/or other devices (e.g., via one or more networks, not depicted). The computing device may also include I/O device(s) 432, such as a keyboard, a mouse, a pen, a voice input device, a touch input device, a display, speakers, a printer, etc.

In some embodiments, the memory 422 may store instructions that, when executed by processor(s) 420 implement the functionality described herein with respect to the anomaly detection engine 402 (e.g., the ADE 102 with respect to FIG. 1). By way of example, Data Receiving Computer(s) 412 may execute the instructions for ADE 102 to provide the functionality described above in connection with FIGS. 1-3. In some embodiments, the ADE 102 may execute on any suitable computer depicted in FIG. 4.

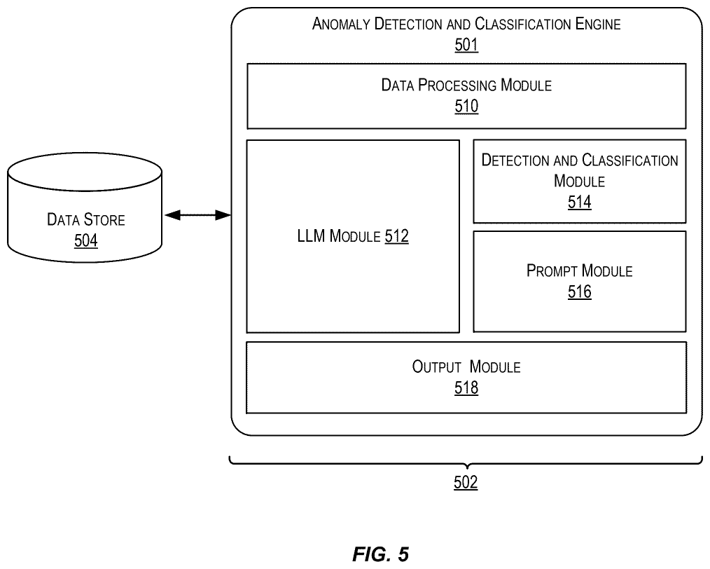

FIG. 5 is a simplified block diagram of an example computer architecture 500 of an anomaly detection and classification engine 501 (e.g., the anomaly detection and classification engine 102 of FIG. 1), in accordance with at least one embodiment. The anomaly detection and classification engine (ADE) 501 may support processes, methods, operations, and techniques discussed in connection with the FIGS. 1-3 and 6 and execute as a separate system or as part of the receiving computer(s) 412 of FIG. 4. The modules 502 of anomaly detection and classification engine 501 may be software modules, hardware modules, or a combination thereof. If the modules are software modules, the modules can be embodied on a computer readable medium and processed by a processor in any of the computer systems described herein. It should be noted that any module or data store described herein, may be, in some embodiments, be a service responsible for providing functionality corresponding to the module described below. The modules 502 may be execute as part of the ADE 501, or the modules 502 may exist as separate modules or services external to the ADE 501. In some embodiments, the modules 502 may be executed by the same or different computing devices, as a service, as an application, or the like.

In the embodiment shown in the FIG. 5, data stores such as a data store 504 (e.g., the LLM data store 103 of FIG. 1) is shown, although data can be maintained, derived, or otherwise accessed from various data stores, either remote or local to the ADE 501, to achieve the functions described herein. The ADE 501, as shown in FIG. 5, includes various modules such as a data processing module 510, an LLM module 512, a detection and classification module 514, a prompt module 516, and an output module 518. Some functions of the modules 510, 512, 514, 516, and 518 are described below. However, for the benefit of the reader, a brief, non-limiting description of each of the modules is provided in the following paragraphs.

Data processing module 510 may include any suitable processing components (e.g., software, hardware, firmware, etc.) operable to support functions, operations, communications, etc. between one or more of modules 512, 514, 516, 518 and data store 103. The data processing module 510 may function to transmit, receive, and/or otherwise communicate with one or more systems or devices over one or more communication networks (e.g., the Internet, wide area networks “WAN”, local area networks “LAN”, a transaction network, etc.). While not depicted, the data processing module 510 need not be physically local to the ADE 501, and may function, at least in part, as a component of a larger network (e.g., cloud network or similar). The data processing module 510 may include any suitable number of supporting hardware components such as processor(s) (e.g., such as processor(s) 420 of FIG. 4), controller(s) (e.g., analog, digital, FPGA, etc.), server(s), non-transitory computer readable mediums such as memory such as RAM and/or ROM (e.g., memory 422 of FIG. 4). The data processing module 510 may be configured to store, retrieve, or transmit such data according to a predetermined periodicity, schedule (e.g., every microsecond, every hour, every day, etc.), frequency, or by request (e.g., user request). In some embodiments, the data processing module 510 may be configured to receive input data (e.g., the input data discussed above).

LLM module 512 may include any suitable number of programs, algorithms, computer readable instructions, that, when executed, interface with a suitable machine-learning model (e.g., an LLM). The LLM module 512 may contain a look-up table or other predefined data indicating a set of pre-existing LLM providers (e.g., LLM Provider(s) 414 with respect to FIG. 4). In some embodiments, the LLM module 512 may provide a list of LLM providers to a user (e.g., using a user interface) enabling the user to select an LLM provider from the list. The LLM module 512 may be configured to store any suitable data corresponding to respective LLMs within data store 504. By way of example, LLM module 512 may be configured to store formatting information indicating one or more attributes, characteristics, application programming interfaces, prompt format, or any suitable data related to one or more LLMs/LLM providers.

Prompt Module 516 may include any suitable number of programs, algorithms, computer readable instructions, that, when executed, generate a prompt (e.g., prompt 107 with respect to FIG. 2) for the ADE 102. The prompt module 516 may obtain input data from the data processing module 510. The prompt module 516 may provide input data as input to an algorithm and/or model in order to transform the input data into the prompt. The prompt module 516 may be configured to partition some or all parts of the input data into various formats which are suitable for one or more LLMs (e.g., according to a format associated with the LLM as stored in data store 504). In some embodiments, the prompt module 516 is configured to communicate with output module 518 based at least in part on prompt generated from the model. In some embodiments, prompt module 516 may provide the prompt to the LLM based at least in part on one or more application programming interfaces identified from the data store 504. The prompt module 516 may be configured to store, retrieve, or transmit such data according to a predetermined periodicity, schedule (e.g., every hour, every day, etc.), frequency, or by request (e.g., user request). As a non-limiting example, the prompt module 516 may be configured to receive and/or obtain one or more data instances corresponding to a user (e.g., one or more transactions associated with a user's account). In some embodiments, the one or more data instances may include a most-recent data instance (e.g., a most-recent transaction). The prompt module 516 may format the one or more instances with one or more sets of classes (e.g., a first set of classes corresponding to anomalous/non-anomalous behaviors, a second set of classes corresponding to one or more categories (e.g., categories such as “food,” “clothing,” “utilities,” “bills,” “loans,” and the like), a third set of classes corresponding to one or more subcategories of the categories (e.g., subcategories such as “dine-in establishments,” “fast food,” “groceries,” each corresponding to the category “food”), and a fourth set of classes corresponding to one or more national code identifiers (e.g., a North American Industry Classification System (NAICS) code).

Detection and classification module 514 may include any suitable number of programs, algorithms, computer readable instructions, that, when executed, determine whether a respective LLM has produced an output which indicates anomalous activity (e.g., an indication that the data instance is fraudulent). The detection and classification module 514 may utilize one or more types of algorithms to identify categories, subcategories, and/or national code identifiers within the output obtained from the LLM. In some embodiments, the detection and classification module 514 may utilize an algorithm or rule set which prioritizes performance such that only particular data instances that meet a set of criteria are analyzed for anomalies and/or for classification of categories, subcategories, and/or national code identifiers (e.g., a data instance having an amount that exceeds a value of 1000 for an account which historically lacks data instances having an amount that exceeds a value of 1000, data instances associated with a user when previous data instances associated with that user have been deemed anomalous, or the like). In some embodiments, the functionality of the detection and classification module 514 may be invoked by the data processing module 510 in response to receiving input data.

Output module 518 may include any suitable number of programs, algorithms, computer readable instructions, or similar to control, interact, provide feedback, provide alerts, provide notifications, and/or operations in response to the detection and classification module 514 determining that information in output provided by the LLM indicates anomalous or non-anomalous data. The output module 518 may include functionality to communicate with one or more user device(s) (e.g., such as user device(s) 108 of FIG. 1 via communication connections 430 of FIG. 4). The operation(s) may include aggregated information from modules 510, 512, 514, 516 and/or the data store 504. For example, the operation(s) may include transmitting a notification to one or more user device(s) 108 that indicates that the detection and classification module 514 has determined that there is a high likelihood (e.g., greater than sixty percent) that a particular data instance is anomalous. In some embodiments, the output module 518 is configured to pause, decline, accept, flag, trigger a review process of the input data (e.g., notifying a user or the ADE 102 to verify an associated data instance), and/or trigger a monitoring process for monitoring a user associated with the input data (e.g., via monitoring subsequent data instances that are associated with the user). In some embodiments, the output module 518 may present any suitable labels corresponding to the categories, subcategories, and/or national code identifiers identified by the output data obtained from an LLM. The output module 518 may aggregate data instances based at least in part on these labels in order to provide a collective view of the data instances corresponding to each label. The output module 518 may be configured to store, retrieve, or transmit such data according to a predetermined periodicity, schedule (e.g., every hour, every day, etc.), frequency, or by request (e.g., user request).

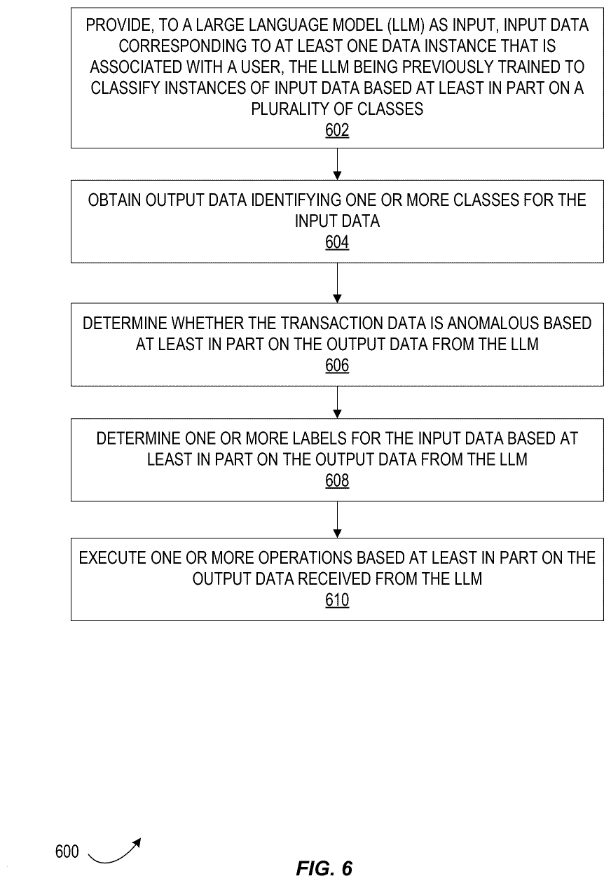

FIG. 6 is a block diagram illustrating an example method 600 for detecting anomalies and classifying data, in accordance with at least one embodiment. A non-transitory computer-readable storage medium may store computer-executable instructions that, when executed by at least one processor, cause at least one computer to perform instructions comprising the operations of the method 600. It should be appreciated that the operations of the method 600 may be performed in any suitable order, not necessarily the order depicted in FIG. 6. Further, the method 600 may include additional, or fewer operations than those depicted in FIG. 6. The operations of method 600 may be performed by any suitable portion of the ADE 102 of FIG. 1 which may include one or more computing devices such as computing device 418 of FIG. 4.

At 602, input data (e.g., input data 305 with respect to FIG. 3, data of a payment transaction) may be provided which corresponds to at least one data instance that is associated with a user may be provided to a large language model (LLM) (e.g., the LLM 104 of FIG. 1) as an input (e.g., prompt 200 with respect to FIG. 2). In some embodiments, the LLM may have been previously trained (e.g., via supervised and/or unsupervised machine-learning algorithms) to classify instances of input data based at least in part on a plurality of classes. By way of example, the LLM may be previously trained to classify one or more data instances provided as input as anomalous or non-anomalous (e.g., fraudulent or legitimate). In some embodiments, the LLM may be trained to identify a category, a subcategory, and/or a national code identifier for a data instance provided as input. In some embodiments, the data instance may be provided to the LLM in a prompt that may include additional data instances that are associated with the user. The prompt may include a first set of classes comprising an anomalous class or non-anomalous class, a second set of classes corresponding to a set of categories (e.g., “food,” “utilities,” “gas,” “clothing,” etc.), a third set of subcategories (e.g., “dine-in establishments,” “fast food,” or “groceries,” all being associated with the category “food,” or the like), or a fourth set of classes corresponding to respective codes or identifiers (e.g., a North American Industry Classification System (NAICS) code, a zip code, or the like), or any suitable combination of the above.

In some embodiments, one or more input data instances are individually associated with a one or more users (e.g., one or more account holders). By way of a non-limiting example, input data including data instances values, data instance types, categories, subcategories, classifications, values, reasons, or combinations thereof may be formatted into the input and transmitted to the LLM for processing (e.g., via an application programming interface or function call specified in data store 504 of FIG. 5). In some embodiments, input data instances may lack a previous association to any suitable combination of a category, a subcategory, a code/identifier, or an anomalous classification. As discussed with respect to FIG. 3, the input, in the form of a prompt, may be formatted for a specific LLM (e.g., based at least in part on format data obtained from data store 504).

At 604, output data (e.g., output data 111 with respect to FIG. 3) identifying one or more classes (e.g., the classes such as “category C,” “subcategory C,” “anomalous,” “457100” of output 311 of FIG. 3) for the input data may be obtained based at least in part on providing the input data to the LLM. In some embodiments, the LLM may be configured to determine one or more classes for the input data from a respective set of classes corresponding to any suitable combination of a category, a subcategory, and/or a code/identifier. The LLM may utilize any suitable combination of the classes identified for the input data (e.g., a category, a subcategory, a code/identifier, or the like) to classify the data instance as belonging to an additional class of a set of classes (e.g., the classes comprising “anomalous,” “non-anomalous,” or “indeterminate”).

At 606, the ADE 501 may determine whether the input data is anomalous based at least in part on the output data from the LLM. By way of example, the ADE 501 may determine that the data instance provided as input is anomalous, non-anomalous, or indeterminate based at least in part on the output data provided from the LLM.

At 608, one or more labels for the input data may be determined based at least in part on the output data from the LLM. As a non-limiting example, the input data may be associated with a label corresponding to a category (e.g., “food”), a subcategory (e.g., “groceries,”), and/or a code/identifier (e.g., a North American Industry Code System (NAICS) code, a zip code corresponding to the location of an entity corresponding to the data instance, or the like). In some embodiments, the determination at 606 may be based at least in part on any suitable combination of the category, subcategory, and/or code/identifier.

At 610, one or more operations may be executed based at least in part on the output data received from the LLM. By way of example, the operations can include any suitable combination of declining further processing of the data instance (e.g., declining the transaction), adjusting a parameter corresponding to the input data, triggering a review process associate with the user (e.g., triggering a manual process for reviewing data that is associated with the user), presenting the one or more labels at a user interface (e.g., presenting category, subcategories, and/or code/identifiers at a webpage at which such data corresponding to the user may be viewed), generating aggregate data of at least one additional data instance corresponding to the user based at least in part on the one or more labels (e.g., showing aggregated data corresponding to a label such as an aggregated amount corresponding to all data instances over a time period (e.g., the last month) that are associated with the label “clothing”), or initiating or adjusting a monitoring process for monitoring the user (e.g., modifying a frequency/periodicity/criteria for which data instances are to be analyzed by the LLM). As a non-limited example, the ADE 501 may be configured to initiate or adjust a monitoring process based at least in part on identifying, from output of the LLM, one or more data instances are identified as being anomalous. If a monitoring process was already ongoing (e.g., every 5^{th} transaction was being sent to the LLM for classification), the monitoring process may be adjusted to a different rate or frequency (e.g., every transaction will be sent to the LLM for classification, every other transaction will be sent to the LLM for classification, etc.).

It should be appreciated that the output data may not be formatted correctly by the LLM. In these instances, the output data may be corrected (e.g., by the ADE 501 of FIG. 5). The ADE 501 may determine that various fields are missing, that the LLM was able to determine if the data instance was anomalous/non-anomalous, or if the anomalous behavior corresponding to the data instance was indeterminate. In some embodiments the ADE 501 may update the input (e.g., prompt 200) with new parameters (e.g., requesting a specific format, updated descriptions, more detailed reasoning, etc.) and resubmit the input to the LLM. In addition, or alternatively, the ADE 501 may submit the updated input, or the original input, to multiple LLMs to achieve a desired result.

The present disclosure provides significant technical advantages over conventional anomaly detection and classification techniques. For example, an LLM may be used to detect anomalous data instances. One or more historical account data transactions (e.g., payment transactions of one or more users) may be provided via prompt to the LLM with a current transaction to be classified/analyzed. The prompt may include a set of possible classifications (e.g., anomalous/fraudulent, non-anomalous/legitimate, etc.), possible categories, possible subcategories, and possible NAICS codes, or any suitable combination of the above. In some embodiments, any suitable combination of a category (e.g., transaction categories such as “food,” “gas,” “utilities,” “clothing,” and the like, such as those that would be used for budgeting purposes), a subcategory (e.g., “dine-in establishments,” “fast food,” “groceries,” or the like, such as those corresponding to a “food” category), and/or codes/identifiers (e.g., a NAICS code, an address, a phone number, a zip code, or the like) may be identified by the LLM for the input data being analyzed/classified.

The system may utilize the LLM provided classifications in a number of ways. For example, a transaction that is classified as anomalous may be declined prior to performing more costly processing. The system may be configured to proceed with the transaction when a classification of non-anomalous is identified. The disclosed techniques may shift the detection of fraudulent transactions closer to the beginning of transaction processing, which may save the system from processing these transactions only to perform detection and perhaps reversal procedures later to remedy the consequences of processing the transaction to begin with. Category, subcategory, and/or NAICS codes may be more accurately identified by an LLM. The category, subcategory and/or NAICS code classification provided by the LLM may be presented to the user and/or utilized to augment account data. This augmented data may provide the user with a clearer view of their account as a whole, enabling the user to ascertain a more detailed understanding of their account, transaction history, and spending behaviors without utilizing system resources to perform this augmentation. Conventional systems would hard code these categories, subcategories, and/or codes/identifiers (e.g., using a map to map entities identifiers such as entity name to categories, subcategories, and/or codes/identifiers) and would be unable to accurately identify unknown entities. The present disclosure remedies these deficiencies enabling the system to make reliable determinations on anomalous/non-anomalous data and/or for category, subcategory, and/or code/identifier, without pre-existing maps, historical records, and/or data which has never before been processed. Additionally, conventional systems may use multiple processes to analyze a transaction for anomaly/fraud detection and to perform additional classifications. The disclosed classifications are provided in single process (e.g., a single prompt, a single input/output pair, etc.) and may reduce wasteful processing resource utilization over systems that initiated multiple, separate processes. Additionally, the disclosed techniques may reduce latency of the system overall as the processing of these classifications may be performed by the LLM.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system can include a number of workstations running any of a variety of commercially available operating systems and other known applications for purposes such as development and database management. These devices can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and application servers. The server(s) may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may include database servers, including without limitation those commercially available from Oracle®, Microsoft®, Sybase®, and IBM®.

The environment can include a variety of data stores and other memory, and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may include one or more storage devices, such as disk drives, optical storage devices, and solid-state storage devices such as random-access memory (“RAM”) or read-only memory (“ROM”), as well as removable media devices, memory cards, flash cards, etc.

Such devices can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices typically will include a number of software applications, modules, services, or other elements located within at least one working memory device, including an operating system and application programs, such as a client application or Web browser. It should be appreciated that alternate embodiments may have numerous variations from that described above. For example, customized hardware might be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Where terms are used without explicit definition as recited herein, it is understood that the ordinary meaning of the word is intended, unless a term carries a special meaning in the field of anomaly detection or other relevant fields. The terms “about” or “substantially”, “similar to”, “similar”, “approximately” are used to indicate a deviation from the stated property or numerical value within which the deviation has little to no influence of the corresponding function, property, or attribute of the structure being described. In an illustrated example, where a dimensional parameter is described as “substantially equal” to another dimensional parameter, the term “substantially” is intended to reflect that the two dimensions being compared can be unequal within a tolerable limit, such as a fabrication tolerance. In the present disclosure, “ranges” refers to a range of values between the two stated extents and/or including one of the two stated extents.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer implemented method, comprising:
collecting, by a computing device, data instances that meet a set of criteria based at least in part on historical data and a prioritized performance;
partitioning, by the computing device, input data into prompt groups based at least in part on input data exceeding a threshold number of the data instances, wherein partitioning the input data into the prompt groups is based at least in part on similar prompt formats having common features from the input data, wherein each prompt in the prompt group includes one or more classes which are examples to be used by a large language model (LLM) to enable classification of the data instances by the LLM into the one or more classes, and wherein the input data includes the data instances that met the set of criteria;
providing, to the LLM as input, the prompt groups corresponding to at least one data instance of the data instances that is associated with one or more users, the LLM being previously trained to classify instances of input data based at least in part on the one or more classes;
based at least in part on providing the prompt groups to the LLM, obtaining, by the computing device, first output data identifying one or more classes for each prompt in the prompt groups;
determining, by the computing device, that a specific type of class of the one or more classes exists in the prompt groups;
generating, by the computing device, a subsequent prompt that includes the specific type of class, wherein the subsequent prompt includes user specific account history that was not provided in the prompt groups;
based at least in part on providing the subsequent prompt to the LLM, obtaining, by the computing device, second output data identifying one or more classes for the subsequent prompt;
determining, by the computing device, a subset of data instances of the at least one data instance that meet a set of criteria;
determining, by the computing device, whether the subset of data instances is anomalous based at least in part on the first output data or the second output data obtained from the LLM;
determining, by the computing device, one or more labels for the subset of data instances based at least in part on the first output data or the second output data obtained from the LLM;
aggregating, by the computing device, the subset of data instances based at least in part on the one or more labels; and
executing, by the computing device, one or more operations based at least in part on the second output data received from the LLM, wherein the one or more operations comprise:
adjusting or initiating, by the computing device, a monitoring process for monitoring subsequent data instances that are associated with a user of the one or more users associated with the subset of data instances; and
displaying, by a graphical user interface, the aggregated data instances and the one or more labels associated with the aggregated data instances.

2. The computer implemented method of claim 1, wherein prompts of the prompt groups further comprise at least one of: a first set of classes comprising an anomalous class or non-anomalous class, a second set of classes corresponding to a set of categories, a third set of subcategories, or a fourth set of classes corresponding to respective codes or identifiers.

3. The computer implemented method of claim 1, wherein the input data is provided in one or more prompts of the prompt groups, the one or more prompts further comprising one or more input data instances that are individually associated with the user.

4. (canceled)

5. The computer implemented method of claim 1, wherein the one or more labels of the subset of data instances differ from an indication of anomalous and non-anomalous behavior.

6. The computer implemented method of claim 1, wherein the one or more operations comprises at least one of: declining further processing of the at least one data instance, adjusting a parameter corresponding to the input data, triggering a review process of the user, presenting the one or more labels at the graphical user interface, generating aggregate data of at least one additional data instance corresponding to the user based at least in part on the one or more labels, wherein adjusting the monitoring process for monitoring the user includes adjusting the monitoring process to be a smaller time interval compared to an initial time interval of monitoring the user.

7. The computer implemented method of claim 1, further comprising:
determining, by the computing device, that the first output data or the second output data obtained from the LLM does not conform to a format; and
providing, by the computing device to the LLM as an additional prompt, the format and the prompt groups.

8. A computing device, comprising:
one or more processors; and
one or more memories storing computer-executable instructions that, when executed by the one or more processors, causes the one or more processors to:
collect data instances that meet a set of criteria based at least in part on historical data and a prioritized performance;
partition input data into prompt groups based at least in part on input data exceeding a threshold number of the data instances, wherein partitioning the input data into the prompt groups is based at least in part on similar prompt formats having common features from the input data, wherein each prompt in the prompt group includes one or more classes which are examples to be used by a large language model (LLM) to enable classification of the data instances by the LLM into the one or more classes, and wherein the input data includes the data instances that met the set of criteria;
provide, to the LLM as input, the prompt groups corresponding to at least one data instance of the data instances that is associated with one or more users, the LLM being previously trained to classify instances of input data based at least in part on the one or more classes;
based at least in part on providing prompt groups to the LLM, obtaining first output data identifying one or more classes for each prompt in the prompt groups;
determine that a specific type of class of the one or more classes exists in the prompt groups;
generate a subsequent prompt that includes the specific type of class, wherein the subsequent prompt includes user specific account history that was not provided in the prompt groups;
based at least in part on providing the subsequent prompt to the LLM, obtain second output data identifying one or more classes for the subsequent prompt;
determine a subset of data instances of the at least one data instance that meet a set of criteria;
determine whether subset of data instances is anomalous based at least in part on the first output data or the second output data obtained from the LLM;
determine one or more labels for subset of data instances based at least in part on the first output data or the second output data obtained from the LLM;
aggregate the subset of data instances based at least in part on the one or more labels; and
execute one or more operations based at least in part on the first output data or the second output data received from the LLM, wherein the one or more operations comprises:
adjusting or initiating, by a computing device, a monitoring process for monitoring subsequent data instances that are associated with a user of the one or more users associated with the subset of data instances; and
displaying, by a graphical user interface, the aggregated data instances and the one or more labels associated with the aggregated data instances.

9. The computing device of claim 8, wherein prompts of the prompt groups further comprise at least one of: a first set of classes comprising an anomalous class or non-anomalous class, a second set of classes corresponding to a set of categories, a third set of subcategories, or a fourth set of classes corresponding to respective codes or identifiers.

10. The computing device of claim 8, wherein the input data is provided in one or more prompts of the prompt groups, the one or more prompts further comprising one or more input data instances that are individually associated with the user.

11. (canceled)

12. The computing device of claim 8, wherein the one or more labels of the subset of data instances differ from an indication of anomalous and non-anomalous behavior.

13. The computing device of claim 8, wherein the one or more operations comprises at least one of: declining further processing of the at least one data instance, adjusting a parameter corresponding to the input data, triggering a review process of the user, presenting the one or more labels at the graphical user interface, generating aggregate data of at least one additional data instance corresponding to the user based at least in part on the one or more labels, wherein adjusting the monitoring process for monitoring the user includes adjusting the monitoring process to be a smaller time interval compared to an initial time interval of monitoring the user.

14. The computing device of claim 8, wherein executing the computer executable instructions further causes the one or more processors to:
determine that the first output data or the second output data obtained from the LLM does not conform to a format; and
provide, to the LLM as an additional prompt, the format and the prompt groups.

15. A non-transitory computer-readable storage medium storing computer-executable instructions that, when executed with one or more processors of a computing device, causes the one or more processors to:
collect data instances that meet a set of criteria based at least in part on historical data and a prioritized performance;
partition input data into prompt groups based at least in part on input data exceeding a threshold number of the data instances, wherein partitioning the input data into the prompt groups is based at least in part on similar prompt formats having common features from the input data, wherein each prompt in the prompt group includes one or more classes which are examples to be used by a large language model (LLM) to enable classification of the data instances by the LLM into the one or more classes, and wherein the input data includes the data instances that met the set of criteria;
provide, to the LLM as input, the prompt groups corresponding to at least one data instance that is associated with one or more users, the LLM being previously trained to classify instances of input data based at least in part on the one or more classes;
based at least in part on providing prompt groups to the LLM, obtaining first output data identifying one or more classes for each prompt in the prompt groups;
determine that a specific type of class of the one or more classes exists in the prompt groups;
generate a subsequent prompt that includes the specific type of class, wherein the subsequent prompt includes user specific account history that was not provided in the prompt groups;
based at least in part on providing the subsequent prompt to the LLM, obtain second output data identifying one or more classes for the subsequent prompt;
determine a subset of data instances of the at least one data instance that meet a set of criteria;
determine whether subset of data instances is anomalous based at least in part on the first output data or the second output data obtained from the LLM;
determine one or more labels for subset of data instances based at least in part on the first output data or the second output data obtained from the LLM;
aggregate the subset of data instances based at least in part on the one or more labels; and
execute one or more operations based at least in part on the first output data or the second output data received from the LLM, wherein the one or more operations comprises:
adjusting or initiating, by a computing device, a monitoring process for monitoring subsequent data instances that are associated with a user of the one or more users associated with the subset of data instances; and
display, by a graphical user interface, the aggregated data instances and the one or more labels associated with the aggregated data instances.

16. The non-transitory computer-readable storage medium of claim 15, wherein prompts of the prompt groups further comprise at least one of: a first set of classes comprising an anomalous class or non-anomalous class, a second set of classes corresponding to a set of categories, a third set of subcategories, or a fourth set of classes corresponding to respective codes or identifiers.

17. The non-transitory computer-readable storage medium of claim 15, wherein the input data is provided in one or more prompts of the prompt groups, the one or more prompts further comprising one or more input data instances that are individually associated with the user.

18. (canceled)

19. The non-transitory computer-readable storage medium of claim 15, wherein the one or more operations comprises at least one of: declining further processing of the at least one data instance, adjusting a parameter corresponding to the input data, triggering a review process of the user, presenting the one or more labels at the graphical user interface, generating aggregate data of at least one additional data instance corresponding to the user based at least in part on the one or more labels, wherein adjusting the monitoring process for monitoring the user includes adjusting the monitoring process to be a smaller time interval compared to an initial time interval of monitoring the user.

20. The non-transitory computer-readable storage medium of claim 15, wherein executing the computer executable instructions further causes the one or more processors to:
determine that the first output data or the second output data obtained from the LLM does not conform to a format; and
provide, to the LLM as an additional prompt, the format and the prompt groups.

21. The method of claim 1, further comprising:
determining, by the computing device, a character limit of the LLM, wherein partitioning the input data into the prompt groups further comprises:
partitioning, by the computing device, the input data into the prompt based at least in part on the character limit of the LLM.

22. (canceled)

23. The non-transitory computer-readable medium of claim 15, wherein the one or more operations comprises:
pause, based at least in part on the monitoring process, processing associated with a specific data instance associated with the user.

24. The method of claim 1, wherein prior to providing the prompt groups to the LLM as the input, the method further comprises:
selecting the LLM from a set of LLMs based at least in part on processing speed and processing power of the LLM.
